(19) United States
(12) Patent Application Publication
(10) Pub. No.: US 2019/0188116 A1
(43) Pub. Date: Jun. 20, 2019

(54) AUTOMATED SOFTWARE TESTING METHOD AND SYSTEM

(71) Applicant: 10546658 CANADA INC., TORONTO (CA)

(72) Inventor: HEIKO ROTH, Toronto (CA)

(21) Appl. No.: 15/848,543

(22) Filed: Dec. 20, 2017

(51) Int. Cl. G06F 11/36

(52) U.S. Cl. CPC G06F 11/3664; G06F 11/3684; G06F 11/3608

(57) ABSTRACT

A method and system for testing software including computer executable instructions in a networked software quality assurance testing system. The method, executed in a processor of a server computing device, comprises determining user type information and a program state model associated with a software application, and presenting a user with at least one action from an action library associated with the program state model and the user type information. Upon selection of the at least one action, generating one or more executable test scripts by causing the software application to advance through program states in accordance with the program state model, the one or more executable test scripts specifying a sequence of test steps based at least partly on the user type information. Executing the software application concurrently with the one or more executable test scripts causes performance of the sequence of test steps upon executing the software application concurrently with the one or more executable test scripts.

### TECHNICAL FIELD

The disclosure herein relates to automated testing of software products and services.

### BACKGROUND

Software quality assurance is tasked with ensuring software applications run error-free on multiple, even seemingly incompatible platforms based on exacting customer and end-user requirements. Software development has traditionally been conducted in distinct stages including a statement of requirements, the development of formal specifications based on the requirements, designing software according to the specifications, then coding the software as designed. Depending upon the intended applications for the software and the resources available for delivering an end product according to desired schedule, multiple verification steps may be performed throughout the software development cycle to maximize the likelihood of successful operation. For example, at the design stage, multiple design reviews may be conducted to ascertain whether the proposed design will achieve specified objectives. Based on results of the design review, the system design may be modified and/or the specifications rewritten. After the system as designed is coded, the resultant software is subjected to testing in order to verify the system design against actual operability achieved. A solution which further contributes to compressing the design, build, test cycle by reducing the software application development cycle time, as well as minimizing the level of specialized test programming expertise required for bringing software to market on time, with error-free performance that meets or exceeds end-user expectations in operation, becomes desirable and provides a significant competitive advantage.

### BRIEF DESCRIPTION OF THE DRAWINGS

FIG. 1 illustrates, in an example embodiment, a networked automated software quality assurance test system.

FIG. 2 illustrates, in one example embodiment, an architecture of a a networked automated software quality assurance testing system.

FIG. 3 illustrates user type information created for a networked automated software quality assurance testing system.

FIG. 4 illustrates, in an example embodiment, a repository of actions usable in conjunction with a networked automated software quality assurance testing system.

FIG. 5 illustrates a method of operation, in one example embodiment, of a networked automated software quality assurance testing system.

### DETAILED DESCRIPTION

Among other benefits and technical effects, it is recognized that, while scripting languages enable a programmer to automate test execution by simulating manual activity using code, use of scripting languages in this manner requires specialized software code expertise, subject to attendant program coding delays and errors commensurate with the programming expertise level applied. Yet further, scripting languages are platform specific, while software applications and business processes, as deployed, may be configured of components that are distributed over multiple platforms, presenting a challenge for functionality across multiple, disparate computing platforms, such as different operating systems and virtual machine systems. This requires that software quality assurance test automation systems execute across the multiple and disparate software and hardware computing platforms, for example in a networked, cloud-based computing system. Among other advantages and technical effects, automated software testing procedures are provided herein to execute tests within a single process that minimizes or eliminates need for specialized program coding expertise, including test scripts program coding expertise, while spanning multiple and disparate computing platforms and software computing applications encountered in order to integrate with business processes, as required by third party applications.

Embodiments herein provide a software quality assurance testing technique of applying aggregated user profile information, also referred to herein as user type information, a hypothetical user profile created to represent the anticipated needs of a common set of users in using a software product or service in a given manner, allowing software QA testers to “step into a customer's shoes” in terms of formulating, or formulated, hypothetical use cases and scenarios that the set of customers are anticipated to execute.

Further contemplated, in one embodiment, is software quality assurance testing of a software application which serves the purpose of employee management and reporting in a business enterprise or company. The application can be used to apply vacation leave requests, fill out employee appraisals, enter, request, and account for timecard- or pay-related information, and multiple other performance metrics for employee reporting and management, and being accessible for use by the entire range of company employees. User type information may be created based on typical users who will use the software application system, including. management, human resources specialists, and employees. The system executes requested testing actions across multiple computing platforms and software applications, based on the different user types in accordance with the user type information.

In accordance with a first example embodiment, a method for testing a software application program is provided. The method, executed in a processor of a server computing device, comprises determining user type information and a program state model associated with a software application, and presenting a user with at least one action from an action library associated with the program state model and the user type information. Upon selection of at least one action, generating one or more executable test scripts by causing the software application to advance through program states in accordance with the program state model, the one or more executable test scripts specifying a sequence of test steps based at least partly on the user type information. The sequence of test steps may be performed upon executing the software application concurrently with the one or more executable test scripts. The one or more executable test script specifying a sequence of test steps based at least partly on the user type information may be stored on computer-readable readable memory and provided to a software test automation controller for testing one or more software applications in a target software test platform. The one or more executable test scripts may execute across multiple software applications concurrently by causing the multiple software applications to advance through program states in accordance with respective program state models of each of the multiple software applications.

In accordance with a second example embodiment, a computer readable medium having program instructions for testing a software application program is provided. The computer readable medium includes program instructions executable in a processor of a computing device to determine user type information and a program state model associated with a software application, and present a user with at least one action from an action library associated with the program state model and the user type information. Upon selection of the action, generating one or more executable test scripts by causing the software application to advance through program states in accordance with the program state model, the one or more executable test scripts specifying a sequence of test steps based at least partly on the user type information. The sequence of test steps may be performed upon executing the software application concurrently with the one or more executable test scripts. In another embodiment, multiple software applications may be concurrently executed in conjunction with the one or more executable test scripts. In yet another variation, the one or more executable test script specifying the sequence of test steps based at least partly on the user type information may be stored on computer-readable readable memory as a test case, component or model, and provided to a software test automation controller for testing one or more software applications in a target software test platform.

In accordance with a third example embodiment, a system for testing a software application program is provided. The system includes a server computing device that includes a memory for storing a software application testing module and one or more processors for executing the software application testing module. The software application testing module includes program instructions for determining user type information and a program state model associated with a software application, and presenting a user with at least one action from an action library associated with the program state model and the user type information. Upon selection of the at least one action, generating one or more executable test scripts by causing the software application to advance through program states in accordance with the program state model, the one or more executable test scripts specifying a sequence of test steps based at least partly on the user type information. The sequence of test steps may be performed upon executing the software application concurrently with the one or more executable test scripts. The sequence of test steps may be performed upon executing the software application concurrently with the one or more executable test scripts. The one or more executable test scripts specifying the sequence of test steps based at least partly on the user type information may be stored on computer-readable readable memory as a test case, component or model, and provided or distributed to one or more software test automation controllers for testing one or more software applications in a target software test platform. The one or more executable test scripts may execute across multiple software applications concurrently by causing the multiple software applications to advance through program states in accordance with respective program state models of each of the multiple software applications.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of logic instructions that are executable by one or more processors of a computing device, including a server computing device. These instructions may be carried on a computer-readable medium. In particular, machines shown with embodiments herein include processor(s) and various forms of memory for storing data and instructions. Examples of computer-readable mediums and computer storage mediums include portable memory storage units, and flash memory (such as carried on smartphones). A server computing device as described herein utilizes processors, memory, and logic instructions stored on computer-readable medium. Embodiments described herein may be implemented in the form of computer processor-executable logic instructions or programs stored on computer memory mediums.

### System Description

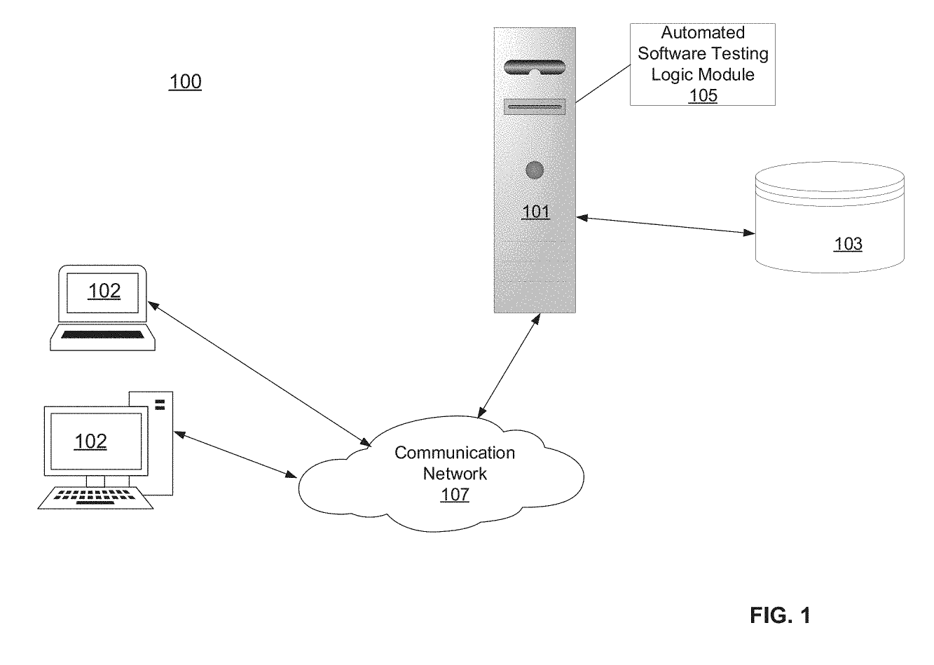

FIG. 1 illustrates, in an example embodiment, automated software testing logic module 105, hosted at server computing device 101, within networked software quality assurance testing system 100. While remote server computing device 101 is depicted as including automated software testing logic module 105, it is contemplated that, in alternate embodiments, alternate computing devices 102, including desktop or laptop computers, in communication via network 107 with server 101, may include one or more portions of automated software testing logic module 105, the latter embodied according to computer processor-executable instructions stored within a non-transitory memory.

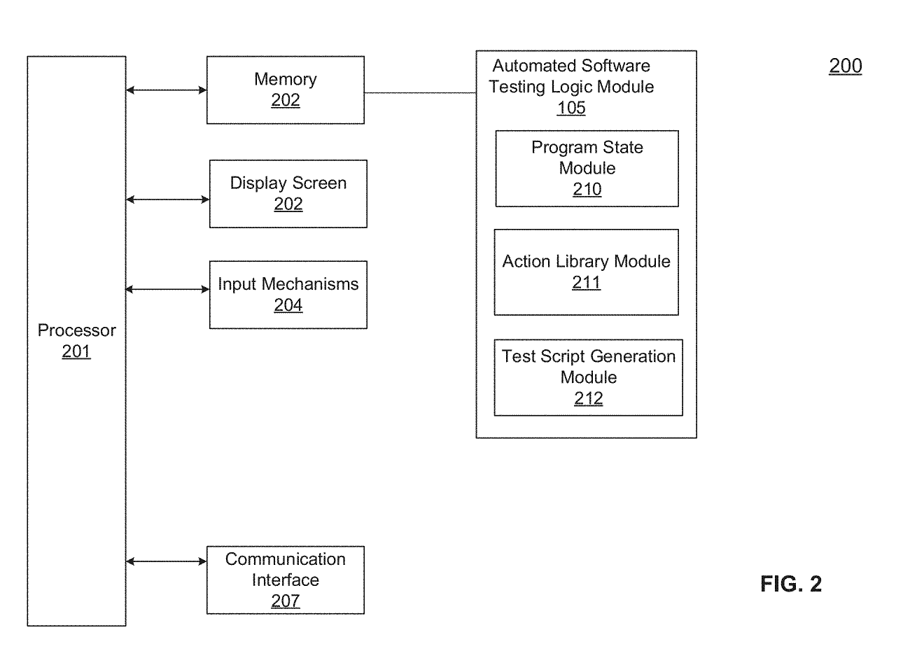

FIG. 2 illustrates architecture 200 of server 101 hosting automated software testing logic module 105, in an example embodiment. Server computing device 101, also referred to herein as server 101, may include processor 201, memory 202, display screen 203, input mechanisms 204 such as a keyboard or software-implemented touchscreen input functionality, and communication interface 207 for communicating via communication network 107.

Automated software testing logic module 105 includes instructions stored in memory 202 of server 101, the instructions configured to be executable in processor 201. Automated software testing logic module 105 may comprise portions or sub-modules including program state module 210, action library module 211 and test script generation module 212.

Processor 201 uses executable instructions of program state module 210 to determine user type information and a program state model associated with a software application under test in a networked software quality assurance testing system.

Processor 201 uses executable instructions stored in action library module 211 to present a user with one or more actions from an action library associated with the program state model and the user type information.

Processor 201 uses executable instructions stored in test script generation module 212 to, upon selection of one or more actions, generate one or more executable test scripts by causing the software application to advance through program states in accordance with the program state model, the executable test scripts specifying a sequence of test steps based at least partly on the user type information; and

Processor 201 uses further instructions stored in automated software testing logic module 105 to perform the sequence of test steps during executing the software application concurrently with the executable test scripts.

Automated software testing logic module 105 may include additional instructions executable in processor 201 to store the generated executable test scripts specifying a sequence of test steps based at least partly on the user type information. The stored executable test scripts may be provided to a software test automation controller for testing one or more software applications in a target software test platform.

Automated software testing logic module 105 may include additional instructions executable in processor 201, whereupon upon occurrence of a pre-determined event, a result from the step of performing the sequence of test steps may be output to a user interface display of computing devices 102 or server 101. The pre-determined event may be any one, or a combination of a non-responsiveness state, a suspension state, and an error state of the software application, a passage of a predetermined period of time, and a usage of an amount of computer memory that exceeds a predetermined threshold amount.

In another example embodiment, the software application and the one or more executable test scripts are executable across multiple software platforms, to perform the sequence of test steps across the multiple software platforms. The multiple software platforms may be defined as being one or more operating systems and virtual machine systems, for instance.

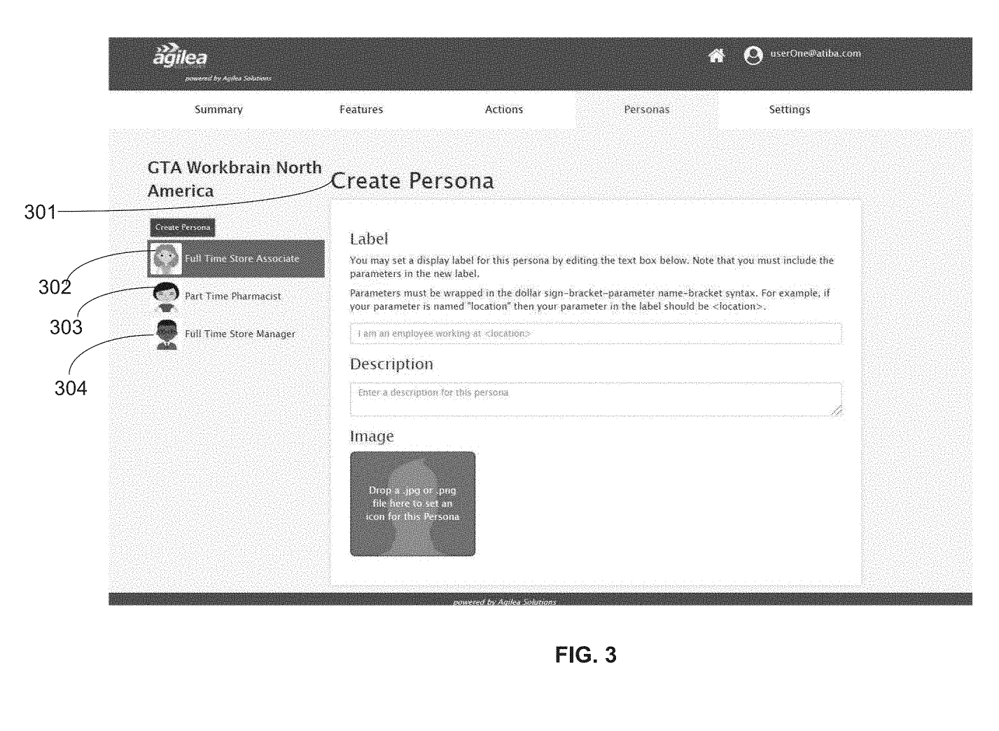

FIG. 3 illustrates, in one example embodiment, creation of a user type 301 for use with networked software quality assurance testing system 100. Example created user types 302-304 may represent a fictional or hypothetical character created to anticipate a type of user that may use a software application under test to achieve a given solution. The user type represents and encapsulates a unique set of user characteristics or attributes that drive a distinctive behavior of a test case within the software application under test. While the user type as created may be hypothetical, the user types may be created based on customer-specific data setups to enable rapid identification of test cases for applying in accordance with the test user types in a software quality assurance testing environment.

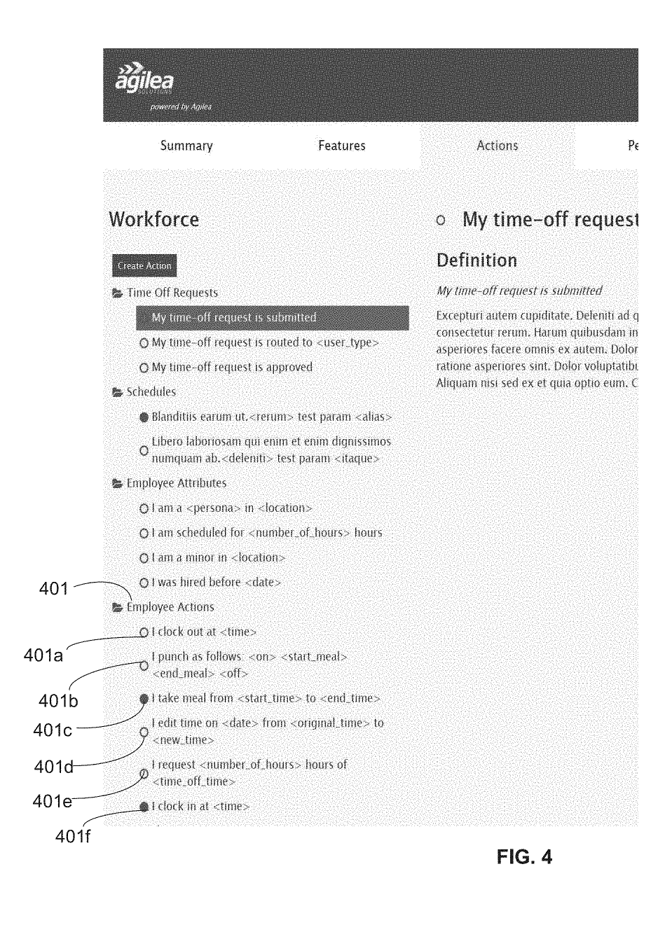

FIG. 4 illustrates, in an enterprise environment example embodiment, a repository of actions usable in conjunction with a networked automated software quality assurance testing system. In one embodiment, the action library including actions 401 collectively may be hosted at database 103 communicatively accessible to server 101 and computing devices 102. An action herein means a unique step in a testing case, such as actions 401a-f of FIG. 4, which defines and mandates a unique test case when used in conjunction with the user type information during software testing. Actions may be re-used across test cases and software test platforms, and may be customizable whereby ‘building blocks’ from the action library are combined to specify a unique test case, eliminating a need for applying specialized coding expertise to writing test scripts or executable code for specific test cases. An action may perform underlying logic of a step, such as writing to a database or making web service calls as linked to code.

### Methodology

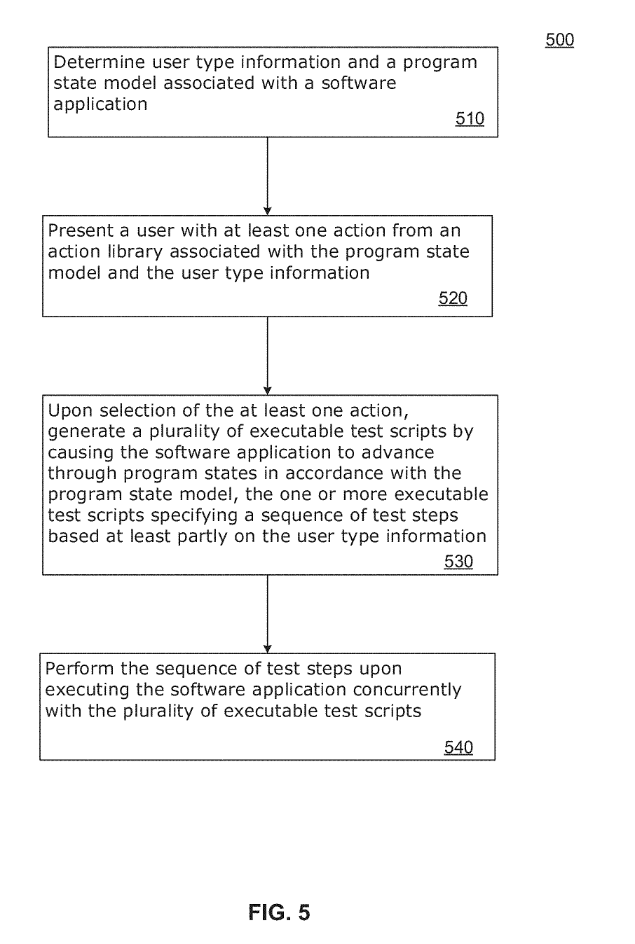

FIG. 5 illustrates, in an example embodiment, method 500 of testing software including computer executable instructions in a networked software quality assurance testing system, method 500 being performed by one or more processors 201 of a computing device. In accordance with the example embodiment of FIG. 1, the computing device may be server computing device 101. In describing examples of FIG. 5, reference is made to the examples of FIGS. 1-4 for purposes of illustrating suitable components or elements for performing a step or sub-step being described.

Examples of method steps described herein relate to the use of server 101 for implementing the techniques described. According to one embodiment, the techniques are performed by automated software testing logic module 105 of server 101 in response to the processor 201 executing one or more sequences of software logic instructions that constitute automated software testing logic module 105. In embodiments, automated software testing logic module 105 may include the one or more sequences of instructions within sub-modules including program state module 210, action library module 211 and test script generation module 212. Such instructions may be read into memory 202 from machine-readable medium, such as memory storage devices. In executing the sequences of instructions contained in program state module 210, action library module 211 and test script generation module 212 of automated software testing logic module 105 in memory 202, processor 201 performs the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions. Additionally, it is contemplated that in alternative embodiments, the techniques herein, or portions thereof, may be distributed between the computing devices 102 and server computing device 101. For example, computing devices 102 may perform some portion of functionality described herein with regard to various modules of which automated software testing logic module 105 is comprised, and transmit data to server 101 that, in turn, performs at least some portion of the techniques described herein.

At step 510, processor 201 of server computing device 101 executes instructions included in program state module 210 to determine user type information and a program state model associated with the software application. The user type information, based on a set of pre-existing hypothetical user attributes or profile created to anticipate likely needs of different user types, may be identified or determined based on unique system login credentials of a given user, regardless of whether a user logs in remotely at desktop and laptop computing devices 102, or locally via user input mechanisms 204 at server computing device 101. In one embodiment, the program state model, such as workforce time may be identified or inferred in connection with an initial information request entered, selected, or otherwise indicated by a user logged in via various computing devices 101, 102.

At step 520, processor 201 executes instructions included in action library module 211 to present a user with at least one action 401a-f from an action library associated with the program state model of the software application and the user type information.

At step 530, processor 201 executes instructions included in test script generation module 212, whereupon upon selection of the at least one action, generate one or more executable test scripts by causing the software application to advance through program states in accordance with the program state model, the one or more executable test scripts specifying a sequence of test steps based at least partly on the user type information. The one or more executable test scripts specifying a sequence of test steps based at least partly on the user type information may be stored in a computer readable medium or memory, then provided as a test case model or component to a software test automation controller for testing one or more software applications in a target software test platform.

At step 540, processor 201 executes further instructions included in automated software testing logic module 105 to perform the sequence of test steps during executing of the software application concurrently with the one or more executable test scripts. In another embodiment, the sequence of test steps, based the generated one or more executable test scripts, may be performed during concurrent execution across multiple software applications, causing the each of the multiple software applications to advance through respective program states in accordance with a program state model of respective ones of the multiple software applications.

In an additional embodiment, upon occurrence of a pre-determined event, a result from the step of performing the sequence of test steps may be output to a user interface display of computing devices 102 or server 101. The pre-determined event may be any one, or a combination of a non-responsiveness state, a suspension state, and an error state of the software application, a passage of a predetermined period of time, and a usage of an amount of computer memory that exceeds a predetermined threshold amount.

In another example embodiment, the software application and the one or more executable test scripts are executable across multiple software platforms, to perform the sequence of test steps across the multiple software platforms. The multiple software platforms may be defined as being one or more operating systems and virtual machine systems, for instance. In another embodiment, the executable test scripts may be applied to concurrently execute across software applications.

Automated software testing logic module 105 may include additional instructions executable in processor 201 to store, in a computer-readable memory or other non-transitory storage medium, one or more generated executable test scripts as a test case, a test component or a model for future use. The result may be provided to a software test automation controller for subsequent use in testing one or more software applications in a target software test environment or platform.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventors from claiming rights to such combinations.

What is claimed is:

1. A method of testing software including computer executable instructions in a networked software quality assurance testing system, the method performed by one or more processors and comprising:
determining user type information and a program state model associated with a software application;
presenting a user with at least one action from an action library associated with the program state model and the user type information; and
upon selection of the at least one action, generating one or more executable test scripts by causing the software application to advance through program states in accordance with the program state model, the one or more executable test scripts specifying a sequence of test steps based at least partly on the user type information.

2. The method of claim 1 further comprising performing the sequence of test steps upon executing the software application concurrently with the one or more executable test scripts.

3. The method of claim 2 further comprising, upon occurrence of a pre-determined event, outputting a result to a user interface display device based on performing the sequence of steps.

4. The method of claim 2 wherein the pre-determined event is at least one of a non-responsiveness state, a suspension state, and an error state of the software application, a passage of a predetermined period of time, and a usage of an amount of computer memory that exceeds a predetermined threshold amount.

5. The method of claim 2 wherein the software application is a first software application, the one or more executable test scripts are executable across multiple software platforms, and further comprising performing the sequence of test steps across the multiple software platforms upon concurrent execution of the first software application and at least a second software application.

6. The method of claim 5 wherein the multiple software platforms are defined by at least one of multiple operating systems and multiple virtual machine systems.

7. The method of claim 1 further comprising:
storing the one or more executable test scripts specifying a sequence of test steps based at least partly on the user type information; and
providing the stored one or more executable test scripts to a software test automation controller for testing one or more software applications in a target software test platform.

8. A server computing device comprising:
a processor;
a memory storing a set of instructions, the instructions executable in the processor to:
determine user type information and a program state model associated with a software application under test in a networked software quality assurance testing system;
present a user with at least one action from an action library associated with the program state model and the user type information; and
upon selection of the at least one action, generate one or more executable test scripts by causing the software application to advance through program states in accordance with the program state model, the one or more executable test scripts specifying a sequence of test steps based at least partly on the user type information.

9. The server computing device of claim 8 further comprising instructions executable in the processor to perform the sequence of test steps upon executing the software application concurrently with the one or more executable test scripts.

10. The server computing device of claim 9 further comprising instructions executable in the processor, whereupon occurrence of a pre-determined event, to output a result to a user interface display device based on performing the sequence of steps.

11. The server computing device of claim 10 wherein the pre-determined event is at least one of a non-responsiveness state, a suspension state, and an error state of the software application, a passage of a predetermined period of time, and a usage of an amount of computer memory that exceeds a predetermined threshold amount.

12. The server computing device of claim 8 wherein the software application is a first software application, the one or more executable test scripts are executable across multiple software platforms, and further comprising performing the sequence of test steps across the multiple software platforms upon concurrent execution of the first software application and at least a second software application.

13. The server computing device of claim 12 wherein the multiple software platforms are defined by at least one of multiple operating systems and multiple virtual machine systems.

14. The server computing device of claim 8 further comprising instructions executable in the processor to:
store the one or more executable test scripts specifying a sequence of test steps based at least partly on the user type information; and
provide the stored one or more executable test scripts to a software test automation controller for testing one or more software applications in a target software test platform.

15. A non-transitory computer readable medium storing instructions executable in one or more processors of a computing device to:
determine user type information and a program state model associated with a software application under test in a networked software quality assurance testing system;
present a user with at least one action from an action library associated with the program state model and the user type information; and
upon selection of the at least one action, generate one or more executable test scripts by causing the software application to advance through program states in accordance with the program state model, the one or more executable test scripts specifying a sequence of test steps based at least partly on the user type information.

16. The non-transitory computer readable medium of claim 15 further comprising instructions executable in the processor to perform the sequence of test steps upon executing the software application concurrently with the one or more executable test scripts.

17. The non-transitory computer readable medium of claim 16 further comprising instructions executable in the one or more processors, upon occurrence of a pre-determined event, to output a result to a user interface display device based on performing the sequence of steps, wherein the pre-determined event is at least one of a non-responsiveness state, a suspension state, and an error state of the software application, a passage of a predetermined period of time, and a usage of an amount of computer memory that exceeds a predetermined threshold amount.

18. The non-transitory computer readable medium of claim 15 wherein the software application is a first software application, the one or more executable test scripts are executable across multiple software platforms, and further comprising performing the sequence of test steps across the multiple software platforms upon concurrent execution of the first software application and at least a second software application.

19. The non-transitory computer readable medium of claim 18 wherein the multiple software platforms are defined by at least one of multiple operating systems and multiple virtual machine systems.

20. The non-transitory computer readable medium of claim 15 further comprising instructions executable in the one or more processors to:
store the one or more executable test scripts specifying a sequence of test steps based at least partly on the user type information; and
provide the stored one or more executable test scripts to a software test automation controller for testing one or more software applications in a target software test platform.
